(19) United States
(12) Patent Application Publication
(10) Pub. No.: US 2020/0278086 A1
(43) Pub. Date: Sep. 3, 2020

(54) HEATING DEVICE FOR IN-SERVICE WELDING OF OIL AND GAS PIPELINE FOR OIL AND GAS TRANSPORT

(71) Applicant: Chongqing University of Science and Technology, Shapingba District (CN)

(72) Inventors: Limeng Yin, Shapingba District (CN); Zhongwen Zhang, Shapingba District (CN); Cunguo Zuo, Shapingba District (CN); Zhangliang Xu, Shapingba District (CN); Chunxiang Wang, Shapingba District (CN)

(21) Appl. No.: 16/804,294

(22) Filed: Feb. 28, 2020

(30) Foreign Application Priority Data
Mar. 1, 2019 (CN) 201910157537.1

(51) Int. Cl. F17D 5/00; F16L 53/30

(52) U.S. Cl. CPC F17D 5/005; F16L 53/30

(57) ABSTRACT

A heating device for in-service welding of oil and gas pipeline, which comprises a heating section, a heat dissipation section and a constant temperature section, wherein the heating section and the heat dissipation section are mounted on an oil and gas pipeline. The heating section heats the oil and gas pipeline to simultaneously heat the wall of the oil and gas pipeline and fluid in the oil and gas pipeline. A work station to be welded is heated by utilizing flowing of the fluid and heat conduction of the wall of the oil and gas pipeline. The heat dissipation section is mounted on the oil and gas pipeline. The heat dissipation section recovers the heat of the oil and gas pipeline by utilizing state change of a heat transfer medium in the heat dissipation section and also transfers the heat to the heating section through the constant temperature section

### TECHNICAL FIELD

The present invention belongs to the technical field of energy transport, and specifically relates to a heating device for in-service welding of oil and gas pipeline for oil and gas transport.

### BACKGROUND

When an oil and gas pipeline has operated for a long time, pipeline wall thinning and even cracks are unavoidable in the inner wall of the oil and gas pipeline. If such problem is not timely processed, the oil and gas pipeline may leak, and more seriously, even result in explosions. The traditional oil and gas pipeline repair method is to release the pressure of the whole oil and gas pipeline, stop oil and gas transport, then repair the affected part. Obviously, this repair method has high costs, and during repairing, the oil and the gas may be released to the environment, causing pollution. Therefore, the prior art provides an in-service welding repair technology, that is, the oil and gas pipeline is repaired in normal service state. Such technology not only maintains the continuity of the oil and gas pipeline, but also greatly reduces oil and gas leakage during repair. However, because the oil and gas resource in the oil and gas pipeline generally is pressurized to be transported, heat loss is great during welding. Furthermore, to avoid rapid cooling of a welding joint during the welding, generally the part to be welded is preheated to avoid premature quenching that could result in welding stress and deformation.

In the prior art, a preheating method before the oil and gas pipeline is welded is to mount a heating device at the front of the part to be welded. This method can help to hold the temperature of the part to be welded at preset temperature, but the fluid in the oil and gas pipeline continuously flows to bring away the heat, so the heating device needs to continuously heat the part, resulting in high energy consumption. Furthermore, only a little heat remains for use in heating the part to be welded after the fluid has dissipated much of the heat, but other heat is dissipated by the flowing of the fluid. Therefore, heat utilization rate is too low.

### SUMMARY

An objective of the present invention is to provide a heating device for in-service welding of oil and gas pipeline, which can quickly heat an oil and gas pipeline and the fluid therein and can also recover the heat from the heated fluid to improve heat utilization rate.

To achieve the above objective, the present invention adopts the following technical solutions:

A heating device for in-service welding of an oil and gas pipeline comprises a heating section, a constant temperature section, and a heat dissipation section. The heating section is formed by a plurality of heating sleeves; the heating sleeve covers an oil and gas pipeline and defines a second layer of the oil and gas pipeline; a sandwich layer of the bilayer oil and gas pipeline communicates with a heated tube in the constant temperature section. The constant temperature section comprises a dual layer, constant-temperature tube and the heated tube; a cooling device; and a booster pump; a partition board is arranged at the middle portion of the constant temperature section to divide the constant temperature section into two separate portions; the heated tube is located in the constant temperature tube; a portion, close to the heating section, of the heated tube communicates with the sandwich layer of the heating sleeve to form a whole body, which is filled with heat transfer oil. The heat dissipation section is formed by a plurality of heat dissipation sleeves; each heat dissipation sleeve has the same structure as the heating sleeve; a hollow portion of the heat dissipation sleeve communicates with the constant temperature tube and is filled with a heat transfer medium; a portion of the booster pump is mounted close to the heat dissipation section, of the constant temperature tube to improve evaporation of the heat transfer medium through increased pressurization; the high-temperature gaseous heat transfer medium condenses to a liquid state at the low-temperature heated tube, and the heat is transferred to the heated tube.

Further, an induction coil is arranged on an inner wall close to the heating section of the constant temperature tube and is used for heating the heated tube. A channel is formed in the induction coil and is used for allowing cooling water to flow in order to prevent a temperature increase of the induction coil from influencing heating efficiency.

Further, a cooling device is arranged outside the constant temperature tube. The cooling device is in direct contact with an inner wall of the constant temperature tube to cool the inner wall of the constant temperature tube and prevent the induction coil from overheating.

Further, the constant temperature tube has two layers. A portion of this tube, at which the partition board is located, has one layer. An outer wall of the constant temperature tube at such portion includes a break. The inner wall of the constant temperature tube is directly in contact with the cooling device to improve cooling efficiency.

Further, the cooling device comprises a fan, cooling fins, and a belt. The cooling fins are mounted on the belt. The belt has two layers, and an interior filled with heat transfer oil. The heat transfer oil transfers the heat of the inner wall of the constant temperature tube to the cooling fins. A shell is arranged outside the cooling fins and is provided with a plurality air holes. The fan is mounted on the shell. The incoming air is directed by the cooling fins of the fan.

Further, a check valve is arranged in an oil and gas pipeline connecting the booster pump and the constant temperature tube.

The present invention can achieve the following technical effects:

(1) under the combined action of the plurality of heating sleeves, the contact area of the heating sleeves and the oil and gas pipeline is increased, and the heat transfer efficiency is improved;

(2) the cooling device introduces circulating water into the induction coil to prevent the induction coil from overheating in order to influence heating efficiency;

(3) the evaporation temperature is increased in by pressurization, and the heat is transferred through a change in state of the water so as to recover the heat;

(4) the heat dissipation sleeves can further recover a part of the welding heat for improved heat utilization.

### BRIEF DESCRIPTION OF THE DRAWINGS

The accompanying drawings of the specification constitute a part of the present specification and provide further understanding of the present invention. The schematic embodiments of the present invention and the description thereof are intended to be illustrative of the present invention and do not constitute an undue limitation of the present invention.

In the drawings:

FIG. 1 is a schematic structural diagram of the present invention.

FIG. 2 is a sectional view of a cooling device of the present invention along an A-A line in FIG. 1.

Wherein the drawings comprise the following reference signs:
1—heating sleeve, 21—heat dissipation sleeve, 22—booster pump, 31—constant temperature tube, 32—induction coil, 33—heated tube, 41—fan, 42—cooling fin, 5—oil and gas pipeline, 6—work station to be welded.

### DESCRIPTION OF THE EMBODIMENTS

It should be noted that the following detailed description is exemplary and aims to further describe the present invention. Unless otherwise defined, all technical and scientific terms used herein have the same meaning as commonly understood by one of ordinary skilled in the art to which the present invention pertains.

It should be noted that the terms used herein are merely used for describing the specific embodiments, but are not intended to limit exemplary embodiments of the present invention. As used herein, the singular form is also intended to include the plural form unless otherwise indicated obviously from the context. Furthermore, it should be further understood that the terms “includes” and/or “including” used in this specification specify the presence of stated features, steps, operations, elements, components and/or their groups.

Moreover, the terms “include”, “contain”, and any other variants mean to cover the non-exclusive inclusion, for example, a process, method, system, product, or device that includes a list of steps or units is not necessarily limited to those steps or units which are clearly listed, but may include other steps or units not expressly which are listed or inherent to such a process, method, system, product, or device.

Spatially relative terms, such as “over”, “above”, “on”, “upper” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings.

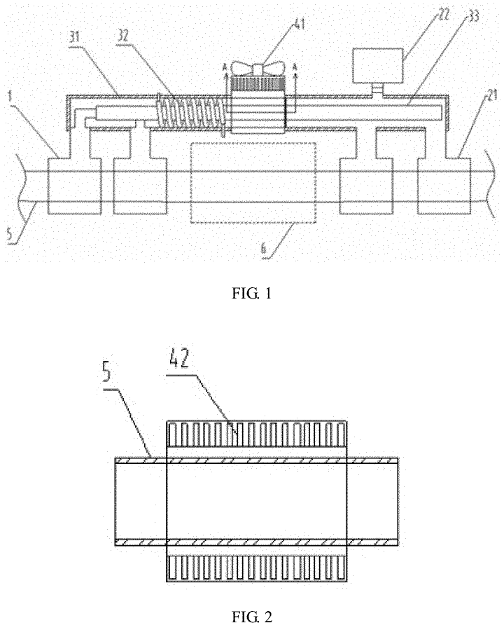

As shown in FIG. 1 and FIG. 2, a heating device for in-service welding of an oil and gas pipeline 5 comprises a heating section, a heat dissipation section, and a constant temperature section, wherein the heating section and the heat dissipation section are mounted on the oil and gas pipeline 5 and are respectively located on two ends of a work station to be welded 6 of the oil and gas pipeline 5. The heating sleeve 1 heats the oil and gas pipeline 5 as well as fluid in the oil and gas pipeline 5 to heat the work station to be welded 6 by utilizing flowing of the fluid and heat conduction of the wall of the oil and gas pipeline 5. The heat dissipation sleeve 21 is mounted on the other side of the work station to be welded 6 of the oil and gas pipeline 5 to absorb the heat of welding and the heat of heating sleeve 1. The heat is transferred to the heating sleeve 1 through the constant temperature tube 31. The heating sleeve 1 and the heat dissipation sleeve 21 are communicated through the constant temperature tube 31. The constant temperature tube 31 is divided into two portions through a cooling fin 42, and a portion close to the heating sleeve 1 is provided with a heating device such as an induction coil 32. The induction coil 32 heats a portion, in communicated with the heating tube 31, of a heated tube 33 to heat the oil and gas pipeline 5, and a portion, close to the heat dissipation section, of the heated tube 33 absorbs the heat absorbed by the heat dissipation sleeve 21, thereby completing heat recovery.

The heated tube 33 comprises a plurality of heating sleeves 1. The heating sleeve 1 covers the oil and gas pipeline 5 and is bilayer. A sandwich layer of the heating sleeve 1 communicates with the heated tube 33 in the constant temperature section to form a whole body such that the heat of the heated tube 33 is transferred to the sandwich layer of the heating sleeve 1 to heat the oil and gas pipeline 5. A portion of the heat is conducted by the oil and gas pipeline 5 while the other portion of the heat is absorbed by the fluid in the oil and gas pipeline 5. The fluid is utilized as a heat conduction medium during flowing, flowing through the work station to be welded 6 to heat it. To heat the work station to be welded 6, one heating sleeve 1 needs more heat to counteract heat loss, which obviously is not economical; therefore, multiple heating sleeves 1 are utilized at the same time, which can be heated at lower temperature and can achieve the same heating effect.

The constant temperature section comprises a bilayer constant temperature tube 31 as well as the heated tube 33, the cooling device and a booster pump 22, which are arranged in the constant temperature tube 31. A partition board is arranged at the middle portion of the constant temperature tube 31 to divide the constant temperature tube 31 into two separated portions. The heated tube 33 is located in the constant temperature tube 31, specifically, it is located in the two portions of the constant temperature tube 31 through the partition board. A portion, close to the heating section of the heated tube 33 is communicated with the sandwich layer of the heating sleeve 1. The heated tube 33 and the sandwich layer of the heating sleeve 1 are full of heat transfer oil, wherein the heat of the heated tube 33 is transferred to the heating sleeve 1 through the heat transfer oil. Furthermore, an inner wall, close to the heating section, of the constant temperature tube 31 is provided with an induction coil 32. The induction coil 32 is used for heating the heated tube 33. The induction coil 32 is hollow, and its hollow portion contains cooling water to prevent temperature increase of the induction coil 32 from influencing heating efficiency.

The cooling device is located outside the constant temperature tube 31. The constant temperature tube 31 is a bilayer tube consisting of an inner wall and an outer wall. The outer wall is broken close to the partition board of the constant temperature tube 31. The inner wall is directly in contact with the cooling device to improve heat dissipation effect. The heat of the heat dissipation section is partially acted on the inner wall of the constant temperature tube 31 to heat it, and the heat is conducted along the inner wall of the constant temperature tube 31 such that the induction coil 32 is heated; therefore, the cooling device needs to reduce the heat of the inner wall of the constant temperature tube 31 to prevent the induction coil 32 from overheating. The cooling device comprises a fan 41, cooling fins 42 and a fixing belt. The cooling fins 42 are mounted on the fixing belt. The fixing belt is hollow and is wound around the inner wall of the constant temperature tube 31 vertical to the flowing direction of the fluid in the oil and gas pipeline 5. The hollow portion of the fixing belt is filled with heat transfer oil to transfer the heat of the inner wall of the constant temperature tube 31 to the cooling fins 42. As shown in FIG. 2, a shell is arranged outside the cooling fins 42. A plurality of air holes are formed in the shell. The fan 41 is mounted on the shell. An air incoming direction of the fan 41 faces to the cooling fins 42, so, when the fan 41 works, outside air is accelerated to enter the shell such that the velocity of air between the shell and the oil and gas pipeline 5 is increased to improve the cooling effect.

As shown in FIG. 1, the heat dissipation device is formed of a plurality of heat dissipation sleeves 21. Each heat dissipation sleeve 21 has the same structure as other heat dissipation sleeves 21 and is a hollow sleeve fixed to the oil and gas pipeline 5. A sandwich layer of the heat dissipation sleeve 21 communicates with the constant temperature tube 31 and is filled with a heat transfer medium. When the temperature of the oil and gas pipeline 5 increases, the heat transfer medium is heated; when the temperature of the heat transfer medium is up to its boiling point, the heat transfer medium is evaporated into high-temperature gas; the high-temperature gas releases its heat and is condensed into liquid to flow back to the heat dissipation sleeve 21 while meeting the low-temperature heated tube.

In the embodiment, the heat transfer medium is water. A preheat temperature is controlled in the range of 220-250° C. At standard atmospheric pressure, the boiling point of the water is 100° C., and the steam temperature is 100° C. Because of this, the booster pump 22 is mounted at the portion, close to the heat dissipation section, of the constant temperature tube 31 to increase the steam temperature in a pressurizing manner. The steam temperature is up to about 250° C. by adjusting the pressure of the booster pump 22. During welding, a large amount of heat is released such that the temperature of the fluid flowing to the heat dissipation sleeve 21 is higher than 250° C., at this time, the water under the high pressure can be evaporated into steam; the steam temperature is higher than the temperature of the heated tube 33 such that the heat is transferred to the heated tube 33 and the steam is condensed into water drops, and a little heat is transferred through the inner wall of the constant temperature tube 31. The portion, close to the heat dissipation sleeve 21 in the constant temperature tube 31, of the heating sleeve 1 is heated such that the liquid in the heated tube 33 is heated. When the temperature of the heat dissipation sleeve 21 cannot achieve a preheat requirements, the preheat temperature is achieved through the heating of the induction coil 32.

It should be noted that a check valve is arranged in an oil and gas pipeline connecting the booster pump 22 and the constant temperature tube 31 to prevent the gas in the constant temperature tube 31 from entering the booster pump 22.

As a preferred embodiment, the type of the heat transfer oil in the heated tube is YD-350L.

In the embodiment, the induction coil 32, the fan 41, the cooling fin 42, the booster pump 22 and the check valve are fabricated by the mature prior art and can be directly purchased so as to not be described in detail herein.

What is claimed is:

1. A heating device for in-service welding of oil and gas pipeline, said device comprising a heating section, a constant temperature section and a heat dissipation section, wherein the heating section is formed by a plurality of heating sleeves; the heating sleeve covers an oil and gas pipeline and is a bi-layer oil and gas pipeline; a sandwich layer of the bi-layer oil and gas pipeline in communication with a heated tube in the constant temperature section; the constant temperature section comprising a bi-layer constant temperature tube, the heated tube, a cooling device and a booster pump; a partition board is arranged at the middle portion of the constant temperature tube to divide the constant temperature tube into two uncommunicated portions; the heated tube is located in the constant temperature tube; a portion, close to the heating section, of the heated tube is communicated with the sandwich layer of the heating sleeve to form a whole body, in which heat transfer oil is filled; the heat dissipation section is formed by a plurality of heat dissipation sleeves; the heat dissipation sleeve has the same structure as the heating sleeve; a hollow portion of the heat dissipation sleeve is communicated with the constant temperature tube and is filled with a heat transfer medium; the booster pump is mounted at a portion, close to the heat dissipation section, of the constant temperature tube to improve evaporation temperature of the heat transfer medium in a pressurizing manner; the high-temperature gaseous heat transfer medium is condensed to be liquid at the low-temperature heated tube, and the heat is transferred to the heated tube.

2. The heating device for in-service welding of oil and gas pipeline according to claim 1, wherein an induction coil is arranged on an inner wall of a portion, close to the heating section, of the constant temperature tube and is used for heating the heated tube; a channel is formed in the induction coil and is used for allowing flowing of cooling water to prevent temperature increase of the induction coil from influencing heating efficiency.

3. The heating device for in-service welding of oil and gas pipeline according to claim 2, wherein a cooling device is arranged outside the constant temperature tube; the cooling device is directly in contact with an inner wall of the constant temperature tube to cool down the inner wall of the constant temperature tube and prevent the induction coil from overheating.

4. The heating device for in-service welding of oil and gas pipeline according to claim 3, wherein the constant temperature tube is bilayer; a portion, at which the partition board is located, of the constant temperature tube is one layer; an outer wall of the constant temperature tube at such portion is broken; the inner wall of the constant temperature tube is directly in contact with the cooling device to improve cooling efficiency.

5. The heating device for in-service welding of oil and gas pipeline according to claim 3, wherein the cooling device comprises a fan, cooling fins, and a sandwich layer is filled with heat transfer oil; the heat transfer oil transfers the heat of the inner wall of the constant temperature tube to the cooling fins; a shell is arranged outside the cooling fins and is provided with a plurality air holes; the fan is mounted on the shell; an air incoming direction of the fan faces to the cooling fins.
